(19) United States
(12) Patent Application Publication
(10) Pub. No.: US 2007/0261181 A1
(43) Pub. Date: Nov. 15, 2007

(54) TELESCOPING RAMP STORED UPON TAILGATE

(76) Inventors: STEPHEN E. WILLARD, Williamsville, MO (US); David E. Edwards, Williamsville, MO (US)

Correspondence Address: Stephen E. Willard, Post Office Box 125, Williamsville, MO, 63967, US

(21) Appl. No.: 11/556,521

(22) Filed: Nov. 3, 2006

Related U.S. Application Data
(60) Provisional application No. 60/733,580, filed on Nov. 4, 2005.

(51) Int. Cl. B60P 1/43

(52) U.S. Cl. 14/71.1

(57) ABSTRACT

A ramp forms from three telescoping sections stored in a box secured to a tailgate of a pickup truck. The sections have an inverted U shape with the branches of the U extending downwards from the cargo bed. The sections extend telescopically with the upper section having the largest width and the lower section being the narrowest width. Each section has a stop the prevents detachment from the preceding section. In use, an all terrain vehicle climbs a pair of the ramps from the ground to the cargo bed, upon the sections, and over a storage box connected to each ramp. In the collapsed ramp, the sections are stored nested in a box clamped upon a tailgate. The ramps are approximately six feet long and collapse into a box approximately three feet high.

### CROSS REFERENCE TO RELATED APPLICATION

This non-provisional patent application claims priority to the provisional patent application 60/733,580 which was filed on Nov. 4, 2005 and is commonly owned by the same inventors.

### BACKGROUND OF THE INVENTION

The telescoping ramp stored upon a tailgate relates generally to cargo loading devices, and more specifically, collapsible ramps.

From the mists of time, hunters have sought game for sustenance and sport. Successful hunters take down game with many weapons, firearms and bows being popular in the present day. When taken, game falls to the earth and the hunter finds it. For big game including deer, a hunter himself may have difficulty returning with the game. Game such as deer range in weight from 50 to 400 lbs. Having shot game, a hunter transports the game from the field to a home, lodge, or other place for dressing, mounting, or other preparation. For short distances and small game, hunters carry the game themselves. For longer distances, bigger game, and quantity of game, hunters transport game upon all terrain vehicles.

Though useful off road and in wilderness areas, all terrain vehicles see limited use on roads. Generally a hunter transports an all terrain vehicle to the proximity of the hunting ground with a larger vehicle such as a pickup truck or towed trailer. Some trailers and most pickup trucks have a tailgate that allows access to the bed for carrying the all terrain vehicle. However, most pickup truck beds are at least three feet from the ground surface. All terrain vehicle operators, hunters among them, have to lift or other wise place the all terrain vehicle in the bed.

### DESCRIPTION OF THE PRIOR ART

All terrain vehicle operators have used cranes, jin poles, lifts, earthen berms, beams, boards, and other devices to raise all terrain vehicles onto a truck bed. These devices and methods burden the operators with additional equipment and cost along with taking time by the operator to install the devices and operate the methods. Some operators have used single piece ramps to raise an all terrain vehicle from the ground to the cargo bed.

Ramps represent one of the oldest machines, the inclined plane. Fixed on both ends but at different elevations, the ramp allows movement of a load between the elevations generally by pushing the load along the ramp. The ramp has seen much use over the centuries and appears in many patents.

For example, the patent to Breslin et al., U.S. Pat. No. 5,813,071, shows a telescoping truck loading ramp for a common U-Haul® truck. This ramp has two sections that nest together and extend in telescoping fashion from the chassis of a cargo truck. In use, the ramp is pulled from the chassis, extended to full length, secured to the cargo bed, and placed at the other end on the ground for use in loading. This ramp has a gentle incline suitable for amateur movers, but has a length nearly half that of the cargo bed itself. The present invention on the other hand has nesting sections that fit within a box secured upon the tailgate of a pickup truck. The sections of the present invention provide an incline accessible by an all terrain vehicle but steeper than that used in the moving industry.

And the patent to Gerwitz, U.S. Pat. No. 6,345,950, shows a ramp of telescoping modular units. The units have a generally U shape with the lower unit nesting within the upper unit. The upper unit has at least two stops that prevent the lower unit from separating from the upper unit. The stops engage a double turned flange at either end of the upper section. In contrast, the present invention has stops placed upon the underside of the section traveled by the tires of an all terrain vehicle. The present invention also has a storage box that functions as the head of the ramp and stores the ramp sections when not in usage.

The present invention overcomes the limitations of the prior art explained above. That is, the art of the present invention allows collapsing an inverted U shaped ramp into a storage container stored upon a pickup truck tailgate. Then with the collapsed ramp stowed, the storage container can be removed from the tailgate as desired by the pickup truck operator. In pairs, the ramps assist an operator in driving an all terrain vehicle onto a cargo bed.

### SUMMARY OF THE INVENTION

Generally, the present invention provides a ramp formed from three telescoping sections stored in a box secured to a tailgate of a pickup truck or other cargo vehicle. The sections have an inverted U shape with the branches of the U extending downwards away from the cargo bed. The sections extend in a telescoping fashion with the first section having the largest width and the third section having the narrowest width. Each section has a centered stop that prevents detachment from the preceding section when the ramp is extended. In use, an all terrain vehicle climbs a pair of the ramps from ground level to the cargo bed by driving up the sections and over a storage box connected to each ramp. When the ramp is collapsed, the sections are stored in a box clamped upon a tailgate. The ramps store nested within the box and the box has a low profile upon the tailgate. The ramps are approximately six feet long and collapse into a box approximately three feet tall.

There has thus been outlined, rather broadly, the more important features of the invention in order that the detailed description thereof that follows may be better understood and that the present contribution to the art may be better appreciated.

Further, the present invention also includes a door that bears all terrain vehicle weight, a box with a hook shape for securing onto a tailgate, padding on the lower surface of the box and within the hook shape, a clamp within the hook shape, an anti-skid surface for the ramp sections, and a locking cover to secure the storage box against theft.

Numerous objects, features and advantages of the present invention will be readily apparent to those of ordinary skill in the art upon a reading of the following detailed description of the presently preferred, but nonetheless illustrative, embodiment of the present invention when taken in conjunction with the accompanying drawings. Before explaining the current embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, the phraseology and terminology employed herein are for the purpose of description and should not be regarded as limiting.

It is, therefore, the principal object of this invention to provide a telescoping ramp that readily mounts upon and extends from a vehicle tailgate such as a pickup truck.

Another object of this invention is to provide a telescoping ramp that collapses into the height of tailgate.

Another object of this invention is to provide a telescoping ramp that stores securely upon a vehicle.

Another object of this invention is to provide for a telescoping ramp that extends faster.

Another object of this invention is to provide for a telescoping ramp that occupies minimum space and volume with a vehicle thus providing room for other gear and equipment.

Lastly, it is an object to provide a telescoping ramp for mounting upon a pickup truck tailgate that can be easily and efficiently manufactured and marketed to the consuming public.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In referring to the drawings,

FIG. 1 shows an end view of a vehicle with two of the present invention installed in accordance with the principles of the present invention;

FIG. 2 describes a side view of the preferred embodiment with the sections extended for usage;

FIG. 3 shows an end view of the box viewing the clamp mechanism;

FIG. 4 shows an end view of the box opposite FIG. 3 showing the compartment for storing the sections;

FIG. 5 describes an end view of a typical section of the preferred embodiment;

FIG. 6 shows a side view of two sections connecting together during usage; and,

FIG. 7 shows an isometric view of a typical section of the preferred embodiment.

The same reference numerals refer to the same parts throughout the various figures.

### DESCRIPTION OF THE PREFERRED EMBODIMENT

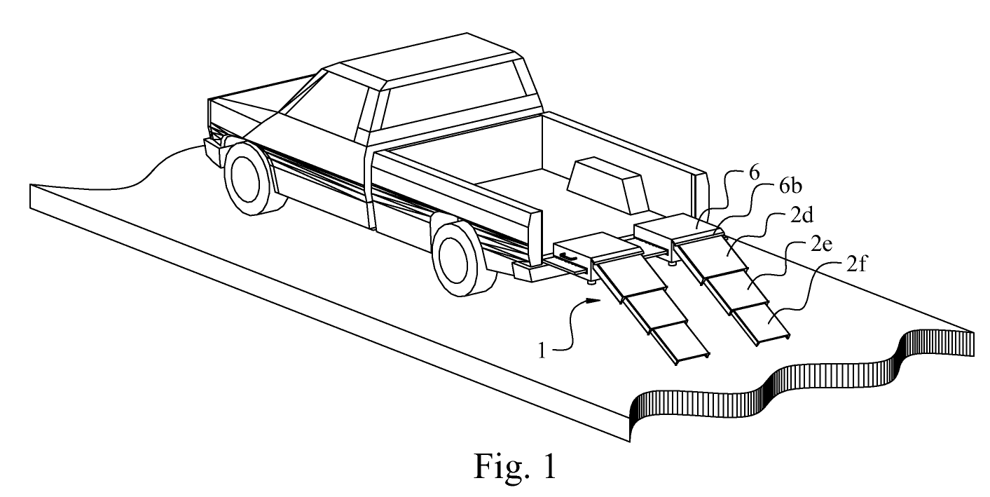

The present art overcomes the prior art limitations by dividing a ramp into manageable sections that store compactly in a box that secures to a tailgate of a vehicle. Though hunters have been described as prime users of this invention, other users of all terrain vehicles, light construction vehicles, and equipment can also use this invention. The equipment must have a wheel weight less than the rated load capacity of the present invention. Thus, when an all terrain vehicle must be loaded or unloaded from a vehicle, such as a pickup truck, two or more of the present inventions or devices 1 are used as shown in FIG. 1.

Presumably an all terrain vehicle has fours wheels and thus two ramps 1 are shown in FIG. 1. Alternatively a motorcycle, wheelbarrow, or other single wheeled equipment may use a single ramp. Viewing two ramps, each ramp has a box 6 placed upon the tailgate of a pickup truck or other vehicle. The box rests upon the edge of the tailgate and has a door, or lid 6b, partially opening away from the tailgate. Beneath the lid, an upper section 2d extends outwards and downwards toward the ground surface below the vehicle. From the upper section, a middle section 2e further extends outwards and downward. The ramp ends with the lower section 2f extending outwards from the middle section opposite the upper section and reaching the ground surface. Each section has a means to secure 5 temporarily to the previous section to prevent further extension or collapse of the ramp during usage. When usage is complete, the sections are released from each other and the lower section nests within the middle section, the middle section nests with the upper section, and the upper section nests within the box. The lid placed over the sections secures them into the box when the ramp is not used and when the vehicle moves.

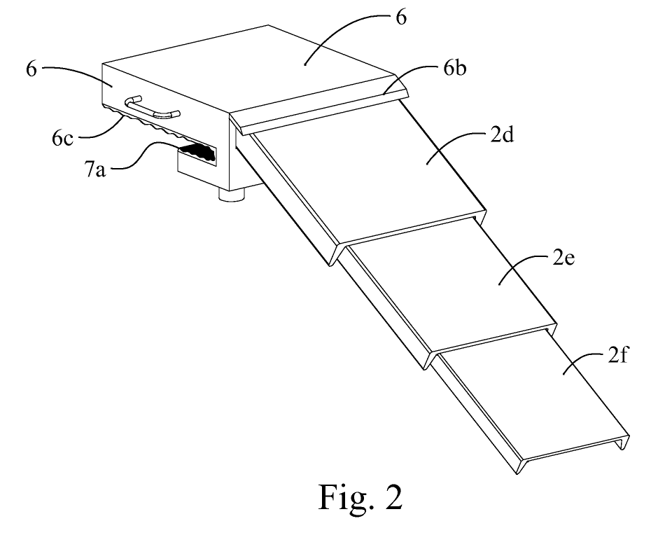

Viewing a single ramp, FIG. 2 shows the present invention 1 extended and from the side. Each section 2 has two mutually parallel and spaced apart legs 4 that extend downwards in a generally inverted U shape. The legs assist in stiffening the section for the loads of an all terrain vehicle when driving upon the section. Each section connects to the adjacent higher section and temporarily secures to the higher section with a notch 5a placed upon a stop 5c. The lower section connects to the middle section of slightly larger width. The middle section connects to the upper section again of slightly larger width. The upper section connects to holes in the sides of the box where the box has slightly larger width than the upper section. A lid 6b from the box 6 extends over the top of the upper section partially down the length of the upper section. The lid assists a wheel of an all terrain vehicle in surmounting the box.

The box 6 has a generally hollow rectangular shape with a hook 7 depending beneath the entrance of the upper section into the box. The box is generally three feet in length, and has a top and an opposite bottom. The hook drops below the box and returns mutually parallel and spaced apart from the bottom of the box. The hook extends partially along the length of the box and not more than the height of the tailgate. Upon the bottom of the box, a pad 6c attaches to the box across the width and along the length of the box thus, cushioning the tailgate when the box is placed upon the tailgate. Opposite the pad and above the hook, a plate 7a also supporting a pad extends generally across the width of the hook. The plate clamps the hook upon the tailgate and the pad upon the plate resists damaging the surface of the tailgate by the plate. Upon one side of the box, a handle extends and assists the driver of the cargo vehicle when carrying the invention away from the tailgate when desired.

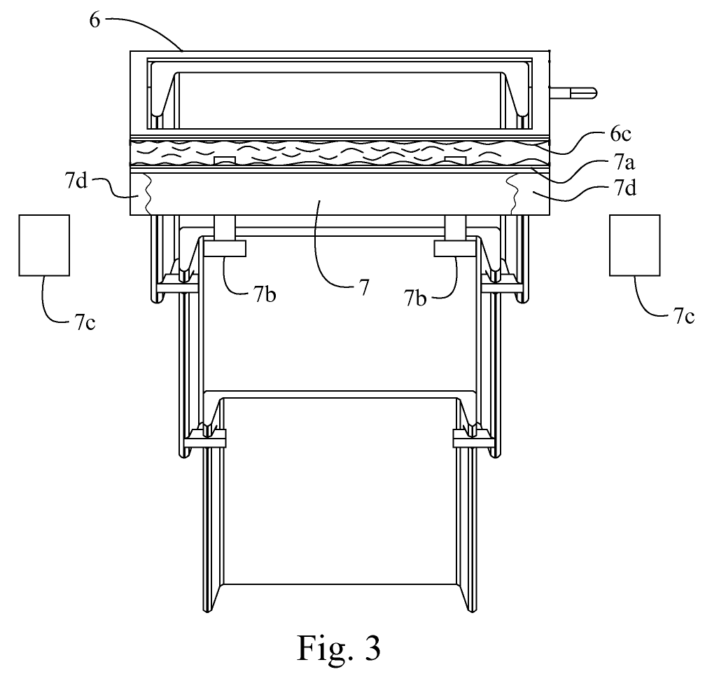

FIG. 3 then shows the box looking into the hook. The box has a generally rectangular cross section here shown with the handle to the right also. The handle attaches to the side of the box and generally above the hook. Also above the hook, a pad 6c attaches to the box and spans the width of the box to protect the tailgate when the box is installed upon a tailgate. The pad is preferably rubber or alternatively an elastomer. Opposite the handle and generally at the bottom of the box, the hook 7 has a generally rectangular cross section. Above the hook, a padded plate 7a spans across the width of the box and has the same length as the inside of the hook. The pad is positioned by at least one clamp 7b and preferably two clamps. Each clamp has a handle, for turning, beneath the hook. A shaft extends away from the handle and reaches a rotatable connection with the plate. Where the shaft passes through the hook, the shaft has threads that engage complementary threads in the hook. Turning of the threaded portion of the shaft advances the plate upon the tailgate for clamping the box into position and retreats the plate from the tailgate to remove the box. At least one spring 7d extends from the padded plate to the outside of the hook. The spring provides a tensile force upon the padded plate that assists in moving the padded plate when the clamps are turned. For security of the box upon the tailgate, the handles can be removed. Alternatively, the handles can be secured by a locking cover 7c. The locking cover extends over a handle and prevents gripping of the handle. The locking cover has a keyed cylinder as a locking mechanism.

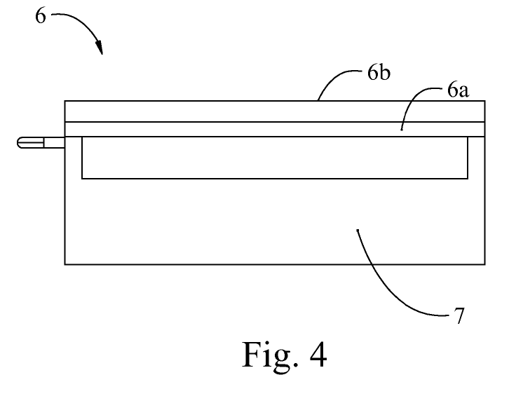

Rotating the box, FIG. 4 shows the opposite view of the box from FIG. 3 with the hook concealed by the end of the box. The box has a generally hollow construction with a compartment upon the upper portion of the box above the hook. The compartment receives the three sections when collapsed for storage into the box. The compartment forms from the top of the box, the two mutually parallel and spaced apart sides perpendicular to the top, and the bottom opposite the top. The bottom has the pad 6c installed in the preceding views of the invention. The compartment has an opening 6a proximate to where the hook extends from the box. The lid 6b hingedly connects to the top across the width of the opening so the lid opens up and away from the hook. The compartment also has two opposed stops 5b (not shown) generally located upon the sidewalls proximate to the opening. The stops 5b accept the notches 5a of the upper section 2d when the ramp is fully extended.

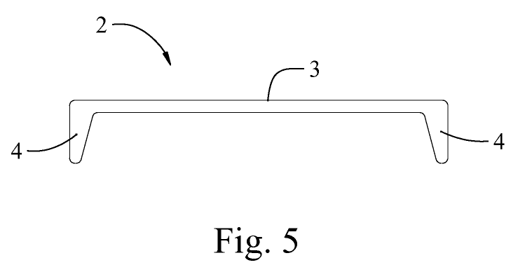

An extended ramp is made from three mutually connected sections. The upper 2d, middle 2e, and lower 2f sections have similar shape but for the width as shown in FIG. 5. The width progressively narrows from upper to lower sections to allow for telescoping of the sections during usage of the ramp and for compact storage of the ramp when collapsed into the box. FIG. 5 shows a cross sectional view of a ramp section that applies to the upper, middle, and lower sections but for the width. A section has two mutually parallel and spaced apart legs 4. The legs are oriented upright to the ground surface when a section is used as part of a ramp. Between the legs, a deck 3 extends perpendicular to both legs and generally parallel to the ground surface when a section sees use as part of a ramp. The deck has an applied anti-slip texture such as a chain grate or diamond pattern. Where one section overlaps another and the upper section connects with the box, the joint requires reinforcement to withstand rated wheel loads.

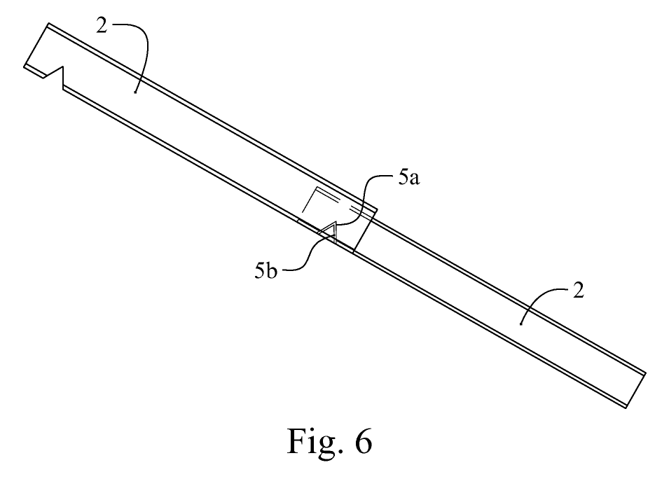

The reinforcement of the joint is typically shown in FIG. 6 with a downhill section engaging a wider uphill section. The downhill section has a notch 5a, generally triangular with the point upwards and extending into each leg. The cooperating triangular stop 5b is fixed to a leg 4 upon an end opposite the notch 5a. The stop is located inwards from the edge of the leg and the notched is located inwards from the edge of the leg as well to provide a rigid connection of two sections 2.

In use, the downhill section is pulled out from the uphill section. As the downhill section extends, the legs pass over the stop. As the notches approach the stop, the angular top of the stop grasps the top edge of the notch hole in the uphill section and guides the downhill onto the stop of the uphill section. The downhill section does not extend completely out of the uphill section. A portion of the legs of the uphill section and the downhill section overlap. When under a wheel load, the downhill section rotates slightly until the legs of the downhill section engage the underside of the deck of the uphill section. Following use, the downhill section is grasped upon the lower end and pushed uphill towards the box. The notches are raised off the stops and thus the downhill section passes along inside the legs of the uphill section. The securing of the upper section to the box is similar to the previous description with the uphill section replaced by the box.

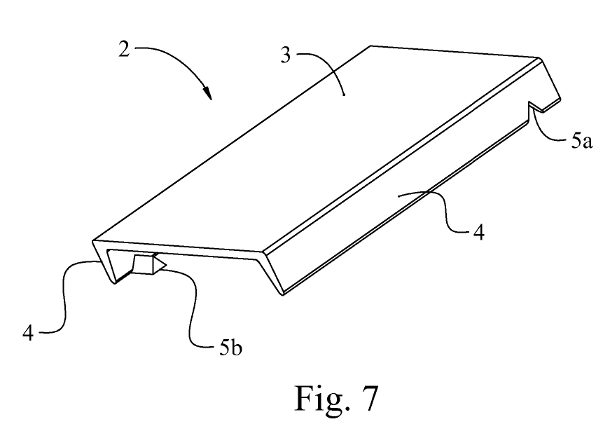

As mentioned previously, the telescoping ramp has an upper section, a middle section, and a lower section with a typical section shown in FIG. 7. The shown section is generally aluminum and has a common shape among the three sections but for the width of the deck. In FIG. 5, a section was described as a generally inverted U shape with a deck and two flanking legs perpendicular to the deck and depending from the deck on the sides. FIG. 6 described securing one section to another using cooperating notches and stops on the legs of adjacent sections. A typical section has a length of approximately two feet with stops 5b in each leg 4 upon one end generally the end located towards the lower end of the ramp and notches 5a on the opposite end, generally the end located towards the upper end of the ramp or towards a tailgate or vehicle. The stops primarily prevent separation of adjacent sections when extended and under a wheel load. The stops are generally of the same material as the legs and joined to the legs in a connection that resists the wheel load applied to the ramp with a factor of safety increase. When the sections are extended, the ramp has a length of approximately six feet.

From the aforementioned description, a telescoping ramp stored upon a tailgate has been described. The telescoping ramp is uniquely capable of providing a ramp that collapses into a box temporarily secured upon a tailgate of a vehicle like a pickup truck. The ramp and its various components may be manufactured from many materials including but not limited to polymers, rugged plastics, steel, ferrous metals, aluminum, and non-ferrous metals and their alloys, and composites.

As such, those skilled in the art will appreciate that the conception, upon which this disclosure is based, may readily be utilized as a basis for the designing of other structures, methods and systems for carrying out the several purposes of the present invention. Therefore, the claims include such equivalent constructions insofar as they do not depart from the spirit and the scope of the present invention.

We claim:

1. A ramp device for elevating equipment from the ground to a transporting vehicle having a tailgate and adapted to be attached to the tailgate, comprising:
at least two telescoping sections, each of said sections having an elongated shape and narrow width, a deck upon which said equipment travels, two spaced apart legs extending longitudinally and generally perpendicular to said deck, an uphill end and an opposite downhill end, one of said sections securing to an adjacent one of said sections when extended longitudinally; and,
a box receiving said sections when said ramp device is collapsed, securing the uppermost section when said ramp device is extended, and locating said ramp device removably upon said tailgate.

2. The ramp device of claim 1 further comprising:
cooperating stops and notches securing said sections when adjacent, said notches locating proximate said uphill end of each of said sections and said stops locating proximate said downhill end of each of said sections; and,
said stops of one section releasably engaging said notches of a second adjacent section thus providing a stable connection of two of said sections and upon lifting said second adjacent section said one section slides into said adjacent second section.

3. The ramp device of claim 2 further comprising:
an upper section;
a middle section, having narrower width than said upper section; and,
a lower section, having narrower width than said middle section thus said lower section nests within said middle section, said middle section nests within said upper section, and said upper section stores within said box.

4. The ramp device of claim 1 further comprising:
said box having a generally rectangular hollow shape, a bottom, and a lateral end, a length sufficient to receive said sections, an opening upon said lateral end, a lid above said opening, a hook beneath said opening and opposite said lid;
said hook extending parallel and spaced apart from said bottom, partially along the length of said box, and partially across said lateral end, and having a movable plate located on the interior of said hook, at least one clamp threadily engaged through said hook and advancing said plate towards said box, and at least one spring engaging said hook and said plate; and,
said hook adapting to fit over the edge of said tailgate with said tailgate positioned between said pad of said box and said padded plate where said at least one clamp then temporarily secures said box to said tailgate.

5. The ramp device of claim 4 wherein said at least one clamp is lockable.

6. The ramp device of claim 4 wherein said plate is padded upon at least one surface of said plate and upon the exterior of said box opposite said lid.

7. The ramp device of claim 1 further comprising:
said legs extending slightly above said deck forming a lip upon both sides of each section, said lip adapted to guide wheels of said equipment to remain upon said deck.

8. The ramp device of claim 2 further comprising:
said legs of the downhill section extend into and between said legs of said uphill section thus further stiffening the connection of two adjacent sections.
